(19) United States
(12) Patent Application Publication
(10) Pub. No.: US 2007/0197084 A1
(43) Pub. Date: Aug. 23, 2007

(54) EMERGENCY SIGNALING SYSTEM

(75) Inventors: Rinaldo Darolfi, Woodbridge, ON (CA); Massimo D. Tari, Woodbridge, ON (CA); Alfredo Darolfi, Woodbridge, ON (CA)

Correspondence Address: RANKIN, HILL, PORTER & CLARK LLP, 4080 ERIE STREET, WILLOUGHBY, OH, 44094-7836, US

(73) Assignee: D & R ELECTRONICS CO., LTD, Bolton (CA)

(21) Appl. No.: 11/464,375

(22) Filed: Aug. 14, 2006

Related U.S. Application Data
(60) Provisional application No. 60/708,147, filed on Aug. 15, 2005.

(51) Int. Cl. H01R 13/58

(52) U.S. Cl. 439/470

(57) ABSTRACT

A signaling device comprises a housing, the housing being arranged for mounting on a roof section of an emergency vehicle, the housing having an upper housing portion and a lower housing portion, a transfer portion for transferring the upper housing portion relative to the lower housing portion between a closed position and an open position, the upper and lower housing portions being further provided with complementary peripheral regions which, when engaged in the closed position, form a weather resistant inner chamber, the upper housing portion having an inner surface, a plurality of signaling elements mounted on the inner surface, the inner surface and/or the signaling elements being operable to be visible to oncoming traffic when the upper housing portion is in the open position.

### REFERENCE TO CO-PENDING APPLICATIONS

The entire subject matter of U.S. Provisional application Ser. No. 60/708,147, filed Aug. 15, 2005 and entitled EMERGENCY SIGNALING SYSTEM is incorporated by reference. The applicant claims priority benefit under Title 35, United States Code, Section 119(e) of U.S. of U.S. Provisional application Ser. No. 60/708,147, filed Aug. 15, 2005 and entitled EMERGENCY SIGNALING SYSTEM.

### BACKGROUND OF THE INVENTION

1. Field of the Invention

This invention relates to emergency signaling and more particularly to emergency signaling systems for emergency vehicles.

2. Description of the Related Art

Emergency vehicles are commonly seen on our nations' highways to control traffic and perform an important function in many cases to alert traffic to emergencies and to provide, where possible, instructions for lane changes and the like, all to promote safer driving. However, conventional lighting systems for emergency vehicles in some cases tend to be bulky and can be impractical for some applications. When mounted on a roof section of an emergency vehicle, conventional lighting systems can have poor aerodynamic characteristics, leading to an increase in fuel consumption and unwanted wind noise.

It would be desirable to address these disadvantages to improve lighting for emergency vehicles.

### SUMMARY OF THE INVENTION

Briefly stated the invention involves a signaling device, comprising a housing, the housing being arranged for mounting on a roof section of an emergency vehicle, the housing having an upper housing portion and a lower housing portion, a transfer portion for transferring the upper housing portion relative to the lower housing portion between a closed position and an open position, the upper and lower housing portions being further provided with complementary peripheral regions which, when engaged in the closed position, form a weather resistant inner chamber, the upper housing portion having an inner surface, a plurality of signaling elements mounted on the inner surface, the inner surface and/or the signaling elements being operable to be visible to oncoming traffic when the upper housing portion is in the open position.

In an embodiment, the lower housing portion further includes a plurality of side wall portions and a base wall portion.

In an embodiment, the lower housing portion includes a first outer peripheral edge region, the lower housing portion further including a top wall portion with an inner peripheral edge region.

In an embodiment, the upper portion has a second outer peripheral edge region to engage the inner peripheral edge region.

In an embodiment, the upper housing portion is substantially planar.

In an embodiment, the second outer peripheral edge region further comprises a skirt member.

In an embodiment, at least one of the inner and second outer peripheral edge regions includes a weather barrier element.

In an embodiment, the side wall portions include at least one outer display surface, the display surface including a plurality of signaling elements.

In an embodiment, the signaling elements include one or more than one speaker, buzzer, light or graphical or numerical readout.

In an embodiment, the one or more than one light includes one or more than one LED, incandescent light element and fluorescent light.

In an embodiment, the transfer portion is operable to transfer the upper housing portion about at least one pivot axis.

In an embodiment, the transfer portion is operable in a first phase to translate the upper housing portion between the closed position and a first intermediate position and a second phase between the first intermediate position and the open position.

In an embodiment, the transfer portion includes a plurality of pivot links

In an embodiment, the transfer portion includes at least one spring element.

In an embodiment, the spring element is operable to bias the transfer portion from the first intermediate position to the closed position and/or from the first intermediate position to the open position.

In an embodiment, the transfer portion includes a support portion extending along the base wall portion, the pivot links include a pair of pivot links of unequal length pivotally connected between the upper housing portion and the support portion.

In an embodiment, the support portion includes an anchor flange, the spring element being coupled between the upper housing portion and the anchor flange.

In an embodiment, the transfer portion includes a linear actuator acting between the lower and upper housing portions.

In an embodiment, the linear actuator is removable from the lower and/or upper housing portions to permit manual closure thereof.

An embodiment further comprises a control portion for controlling the signaling elements. In an embodiment, the control portion includes a processor portion operable to communicate with the signaling elements.

In an embodiment, the control portion includes a control housing enclosing the processor portion.

In an embodiment, the control housing is positioned on the base wall panel.

An embodiment further comprises a plurality of cables between the processor portion and the signaling elements to form a plurality of communication paths therebetween.

In an embodiment, the upper housing portion includes an outer skin element and an inner skin element, the outer and inner skin elements being spaced to form a space to receive the cables.

An embodiment further comprises a heating element for heating the inner chamber.

In another of its aspects, the present invention provides an emergency signaling device mountable on an emergency vehicle, comprising a first outer display portion and a second inner display portion nested therewith, the second inner display portion being movable relative to the first outer display portion between an inclined position and an upright position, the second inner display portion, when in the inclined position, having a common lower periphery and/or and a common upper periphery with the first outer display portion, the first outer display portion having an outer circumferential first display surface, a plurality of signaling elements positioned along the outer circumferential first display surface, the second inner display portion having at least one planar second display surface bearing a plurality of signaling elements, the second display surface being visible to oncoming traffic when the second inner display portion is in the inclined position.

An embodiment further comprises a frame portion, the second inner display portion being pivotally coupled to the first outer display portion and or the frame portion.

In an embodiment, the first outer display portion includes at least one transverse portion to be oriented with a transverse axis of the vehicle, the first transverse portion including a first transverse boundary, the second inner display portion having a second transverse boundary which is complementary with the first transverse boundary.

In an embodiment, the first outer display portion includes a pair of opposed first transverse portions to be oriented with a transverse axis of the vehicle, each of the first opposed transverse portions having a first transverse boundary, the second inner display portion including a pair of opposed second transverse boundaries, each of which is complementary with a corresponding first transverse boundary.

In an embodiment, the first outer display portion includes a pair of opposed first longitudinal portions to be oriented along a longitudinal axis of the vehicle, each of the opposed first longitudinal portions having a first longitudinal boundary, the second inner display portion including a pair of opposed second longitudinal boundaries, each of which is complementary with a corresponding first longitudinal boundary.

In an embodiment, the first outer display portion has a bottom wall, wherein the opposed first transverse portions, the opposed first longitudinal portions and the bottom wall cooperate with the second outer display portion to form an interior chamber therein.

An embodiment further comprises a weather resistant element located on the first outer display portion and/or the second outer display portion for maintaining the chamber in an at least partially weather resistant condition, when the second outer display portion is in the inclined position.

An embodiment further comprises a transfer portion for transferring the second display portion from the inclined position to the upright condition.

In another of its aspects, the present invention provides a vehicle comprising a roof section, signaling device mounted on the roof section, the signaling device including a housing, the housing being arranged for mounting on a roof section of an emergency vehicle, the housing having an upper housing portion and a lower housing portion, a transfer portion for transferring the upper housing portion relative to the lower housing portion between a closed position and an open position, the upper and lower housing portions being further provided with complementary peripheral regions which, when engaged in the closed position, form a weather resistant inner chamber, the upper housing portion having an inner surface, a plurality of signaling elements mounted on the inner surface, the inner surface and/or the signaling elements being operable to be visible to oncoming traffic when the upper housing portion is in the open position.

In another of its aspects, the present invention provides an emergency vehicle, comprising an emergency signaling unit having a first outer display portion and a second inner display portion nested therewith, the second inner display portion being movable relative to the first outer display portion between an inclined position and an upright position, the second inner display portion, when in the inclined position, having a common lower periphery and/or and a common upper periphery with the first outer display portion, the first outer display portion having an outer circumferential first display surface, a plurality of signaling elements positioned along the outer circumferential first display surface, the second inner display portion having at least one planar second display surface, the second display surface being visible to oncoming traffic when the second inner display portion is in the inclined position.

In another of its aspects, the present invention provides an emergency signaling device mountable on an emergency vehicle, comprising a first outer display means and a second inner display means nested therewith, the second inner display means being movable relative to the first outer display means between an inclined position and an upright position, the second inner display means, when in the inclined position, having a common lower periphery and/or and a common upper periphery with the first outer display means, the first outer display means having an outer circumferential first display surface, a plurality of signaling means positioned along the outer circumferential first display surface, the second inner display means having at least one planar second display surface, the second display surface being visible to oncoming traffic when the second inner display means is in the inclined position.

In another of its aspects, the present invention provides a signaling device, comprising a housing means, the housing means being arranged for mounting on a roof section of an emergency vehicle, the housing means having an upper housing means and a lower housing means, a transfer means for transferring the upper housing means relative to the lower housing means between a closed position and an open position, the upper and lower housing means being further provided with complementary peripheral regions which, when engaged in the closed position, form a weather resistant inner chamber means, the upper housing means having an inner surface, a plurality of signaling means mounted on the inner surface, the inner surface and/or the signaling means being operable to be visible to oncoming traffic when the upper housing means is in the open position.

In another of its aspects, the present invention provides a method of providing emergency signaling on an emergency vehicle, comprising the steps of providing a housing, arranging the housing to be mountable on a roof section of the emergency vehicle, providing the housing having with an upper housing portion and a lower housing portion, transferring the upper housing portion relative to the lower housing portion between a closed position and an open position, providing the upper and lower housing portions with complementary peripheral regions which, when engaged in the closed position, form a weather resistant inner chamber, providing the upper housing portion with an inner surface, locating one or more signaling elements on the inner surface, and arranging the inner surface and/or the signaling elements to be visible to oncoming traffic when the upper housing portion is in the open position.

In another of its aspects, the present invention provides a method of providing emergency signaling on an emergency vehicle, comprising a step for providing a housing, a step for arranging the housing to be mountable on a roof section of the emergency vehicle, a step for providing the housing having with an upper housing portion and a lower housing portion, a step for transferring the upper housing portion relative to the lower housing portion between a closed position and an open position, a step for providing the upper and lower housing portions with complementary peripheral regions which, when engaged in the closed position, form a weather resistant inner chamber, a step for providing the upper housing portion with an inner surface, locating one or more signaling elements on the inner surface, and a step for arranging the inner surface and/or the signaling elements to be visible to oncoming traffic when the upper housing portion is in the open position.

In another of its aspects, the present invention provides a signaling device, comprising a housing, the housing being arranged for mounting on a roof section of an emergency vehicle, the housing having an upper housing portion and a lower housing portion, a transfer portion for transferring the upper housing portion relative to the lower housing portion between a closed position and an open position, the upper and lower housing portions being further provided with complementary peripheral regions which, when engaged in the closed position, form a weather resistant inner chamber, the upper housing portion having an inner surface, at least one signaling element mounted on the inner surface, the inner surface and/or the at least one signaling element being operable to be visible to oncoming traffic when the upper housing portion is in the open position.

In another of its aspects, the present invention provides an enclosure comprising a housing, the housing being arranged for mounting on or in a vehicle, the housing having an upper housing portion and a lower housing portion, a transfer portion for transferring the upper housing portion relative to the lower housing portion between a closed position and an open position, the upper and lower housing portions being further provided with complementary peripheral regions which, when engaged in the closed position, form a weather resistant inner chamber, the upper housing portion having an inner surface, the transfer portion being operable in a first phase to translate the upper housing portion between the closed position and a first intermediate position and a second phase between the first intermediate position and the open position, the transfer portion including at least one spring element which is operable to bias the transfer portion from the first intermediate position to the closed position and/or from the first intermediate position to the open position.

In another of its aspects, the present invention provides an emergency signaling device mountable on an emergency vehicle, comprising a housing with a weather resistant inner chamber when the housing is in a closed position, the housing having at least one outer surface supporting at least one signaling element, the housing having at least one inner surface, the housing including at least two housing portions which, when deployed from the closed position to an open position, exposes the inner surface, the inner surface supporting at least one signaling element to be visible to oncoming traffic.

In another of its aspects, the present invention provides a method of signaling oncoming vehicular traffic, comprising the steps of providing an emergency signaling device with a weather resistant inner chamber when the housing is in a closed position, providing the housing with at least one outer surface supporting at least one signaling element, providing the housing with at least one inner surface, the housing including at least two housing portions which, when deployed from the closed position to an open position, exposes the inner surface, the inner surface supporting at least one signaling element to be visible to oncoming traffic.

### BRIEF DESCRIPTION OF THE DRAWINGS

Several preferred embodiments of the present invention will now be described, by way of example only, with reference to the appended drawings in which:

FIGS. 1 and 2 are schematic perspective views of a signaling device in an operative position on a vehicle;

FIGS. 3 to 5 are perspective views of the device of FIG. 1 in different operative positions;

FIGS. 6 and 7 are fragmentary perspective and plan views, respectively, of the device of FIG. 1;

FIGS. 8 to 11 are schematic operative side views of the device of FIG. 1; and

FIGS. 12a to 12e are schematic side views of another signaling device.

### DESCRIPTION OF THE PREFERRED EMBODIMENTS

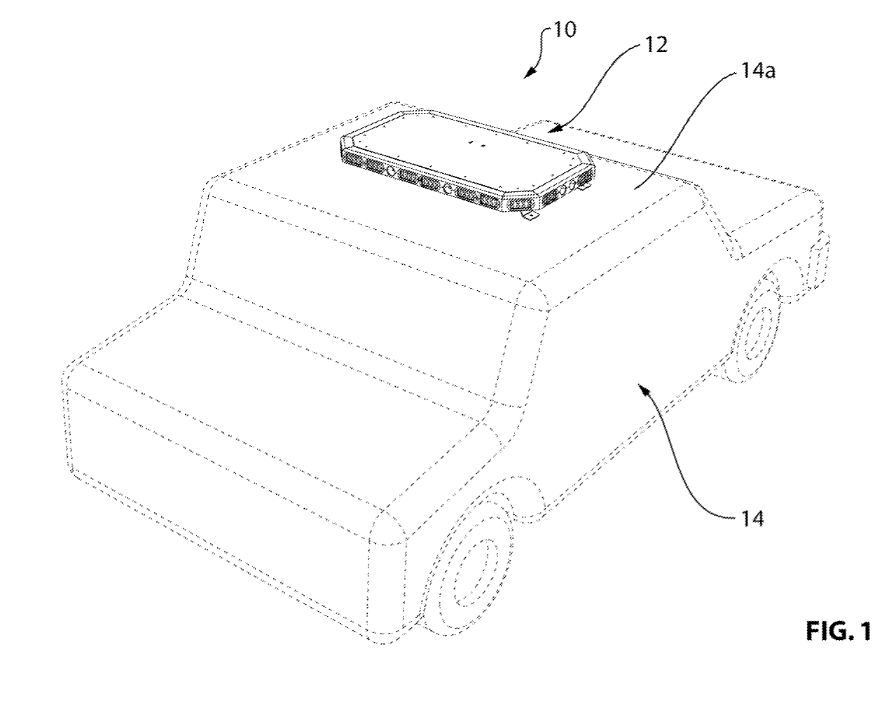

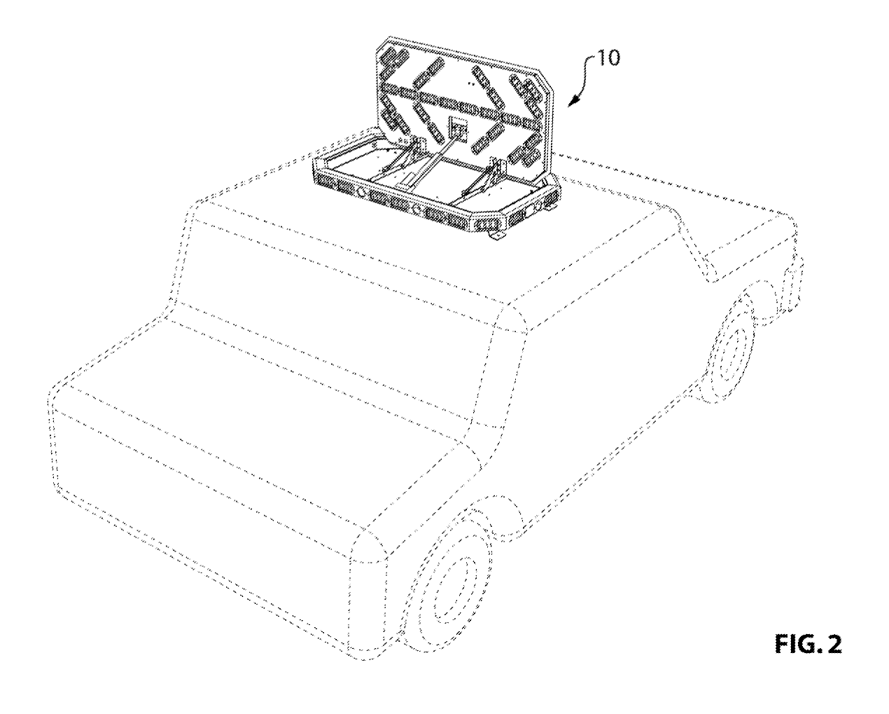

Referring to figure the figures, there is provided a signaling device 10 including a housing 12 which is arranged for mounting on a roof section 14a of an emergency vehicle 14, as can be seen in FIG. 1.

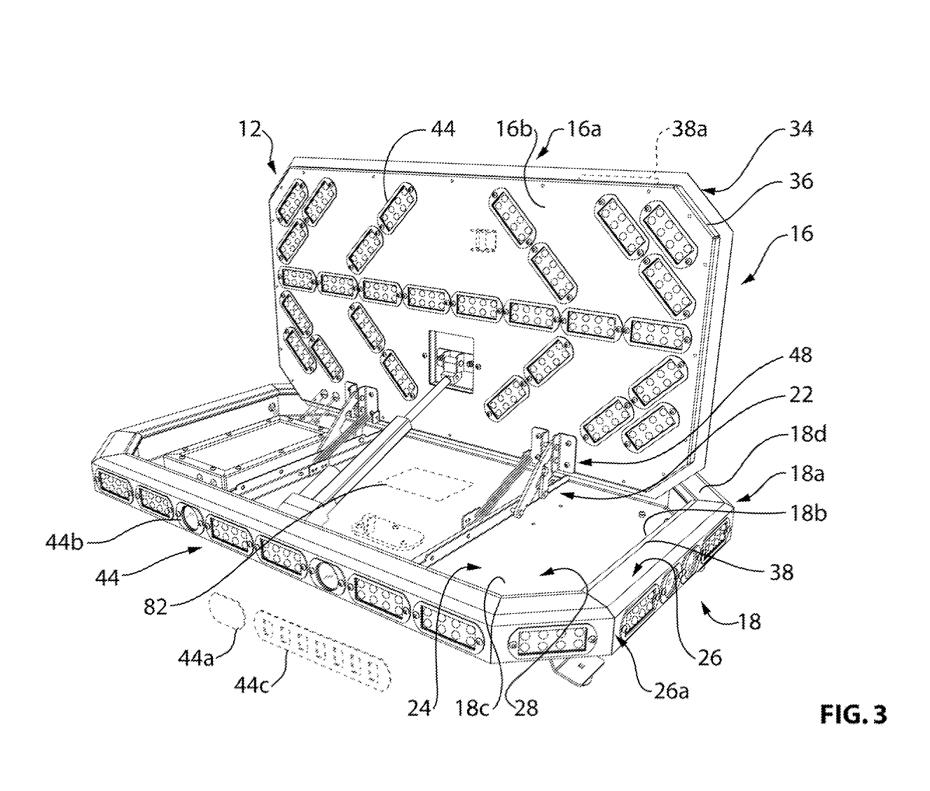

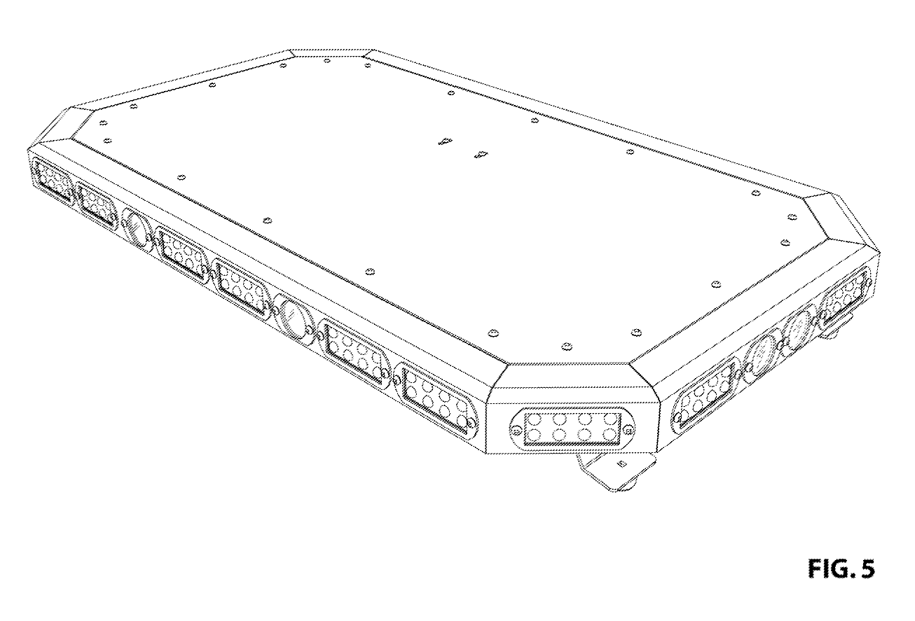

Referring to FIGS. 3, 5 and 6, the housing 12 has an upper housing portion 16 and a lower housing portion 18. A transfer portion shown generally at 22 transfers the upper housing portion 16 relative to the lower housing portion 18 between a closed position, shown in FIG. 5, and an open position as shown in FIG. 3. The upper and lower housing portions 16, 18 are further provided with complementary peripheral regions which, when engaged in the closed position, form a weather resistant inner chamber 24.

The lower housing portion 18 is provided with a plurality of side wall portions 26, a base wall portion 28 and a first outer peripheral edge region 18a. The lower housing portion 18 further includes a top wall portion 18d with an inner peripheral edge region 18b.

The upper housing portion 16 has a second outer peripheral edge region 16a to engage the inner peripheral edge region 18b and includes a substantially planar upper panel 34. Positioned on the upper panel 34 and in the vicinity of the second outer peripheral edge region 16a is a skirt member 36 for engaging the lower housing portion 18 near the inner peripheral edge region 18d in the closed position.

The inner peripheral edge region 18b is further equipped with a weather barrier element 38, though a weather barrier element may be provided, alternatively or in combination, on the outer peripheral edge region, as desired, as shown in dashed lines at 38a in FIG. 3.

The side wall portions 26 include at least one outer display surface 26a with a number of passages 26b, each providing a location for mounting at least one or a plurality of signaling elements 44. In this case, the signaling elements 44 may include one or more than one speaker or buzzer 44a, light 44b, or a graphical or numerical readout 44c. The lights may include one or more than one LED, incandescent light element and fluorescent light, though other lights or other signaling elements may also be used as desired. The signaling elements may also include reflective tapes, paints or other reflective portions or means. The signaling elements may also include phosphorescent or fluorescent portions or means.

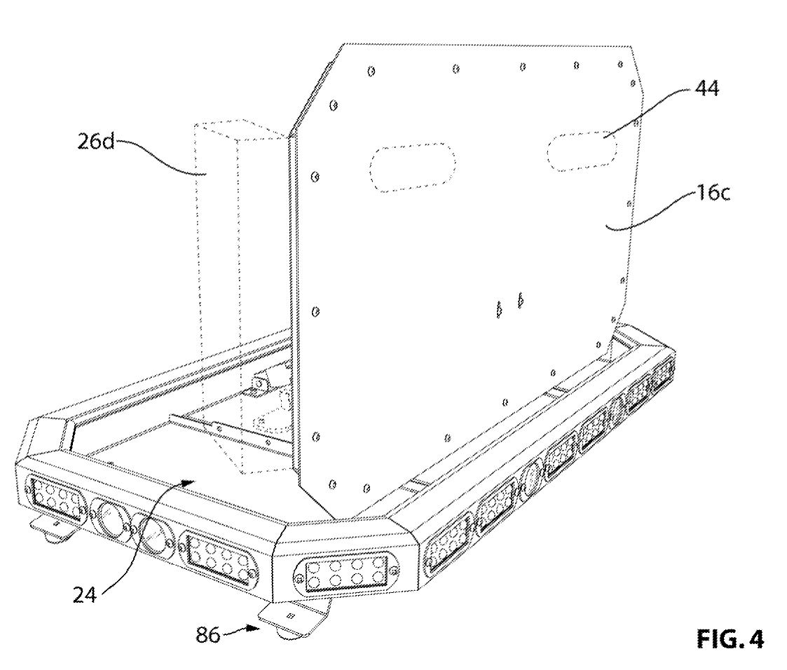

The upper housing portion 16 has an inner surface 16b which also carries at least one or a plurality of signaling elements 44. Thus, when the upper housing portion 16 is in the open position, the inner surface 16b and/or the signaling elements 44 on it are visible to oncoming traffic. The upper housing portion 16 also has an outer surface 16c and one or more signaling elements 44 may be provided on the outer surface as desired, as shown in FIG. 4. In this case, signaling elements 44, described above for the outer display surface 26a may also be used on the inner surface 16b or outer surface 16c, as desired.

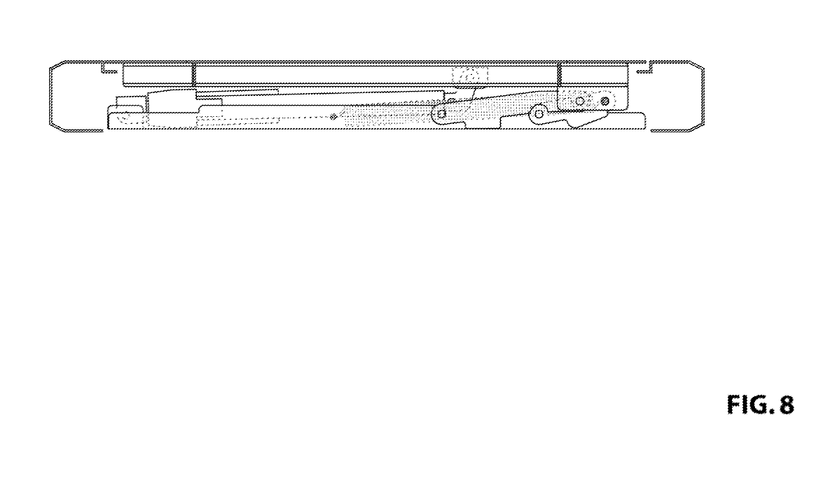

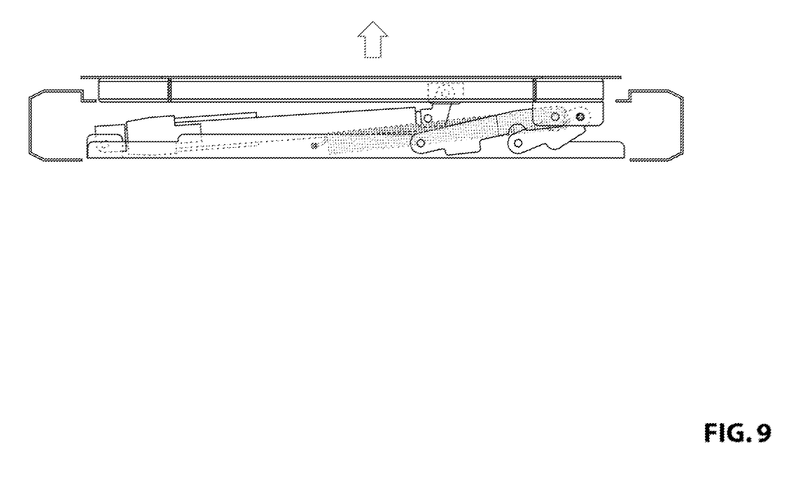

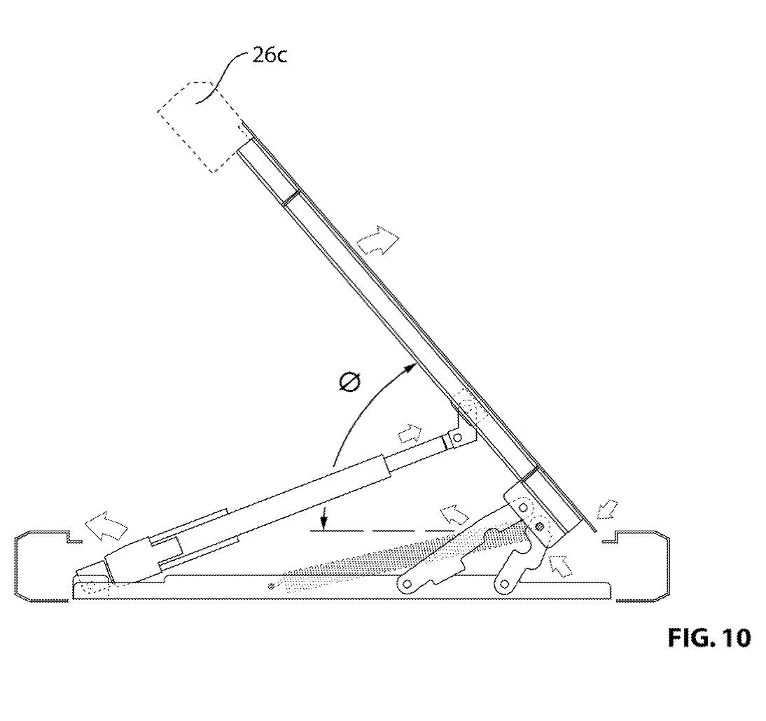

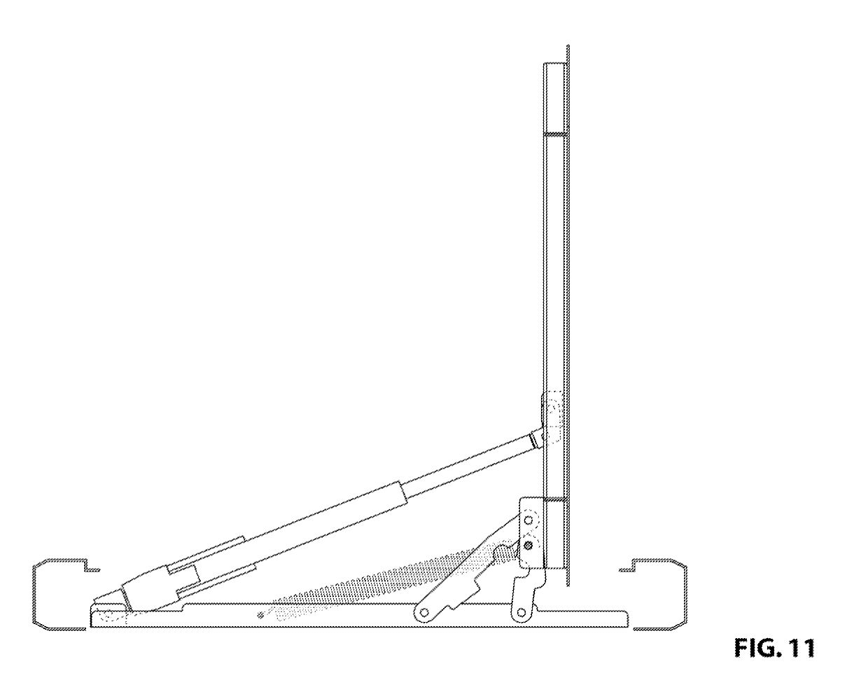

The transfer portion 22 is operable to transfer the upper housing portion 16 about at least one pivot axis. The transfer portion 22 is operable in a first phase to translate the upper housing portion 16 between the closed position shown in FIG. 8 and a first intermediate position shown in FIG. 10 and a second phase between the first intermediate position and the open position as shown in FIG. 11. In this case, the intermediate position is determined by the relative dimensions of the transfer portion and may be, in one example, at an angle “theta” ranging from about thirty degrees to about fifty degrees, relative to the base wall portion and more preferably at an angle of about forty degrees.

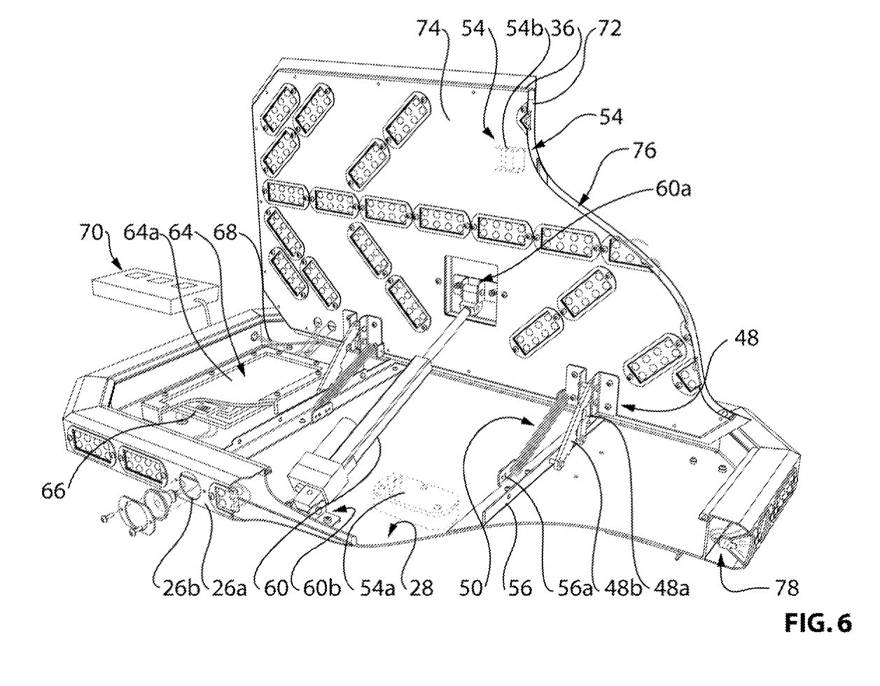

Referring to FIG. 6, the transfer portion 22 includes two sets of hinge mechanisms 48, each with a pair of pivot links 48a, 48b and a tension spring element 50. The spring element 50 is operable to bias the transfer portion 22 from the first intermediate position to the closed position to contribute to a firm an effective closing of the device 10 without the need for a separate latch mechanisms.

That being said, a latch mechanism 54 may be provided as shown at 54 to latch the device 10 in the closed position and which may also be provided, for example, with a solenoid or manually triggered clasp shown in dashed lines at 54a to engage a latch shown at 54b.

In addition, the spring element 50 is operable to bias the transfer portion 22 from the first intermediate position to the open position, to aid in deploying the device 10. The pivot links 48a, 48b and spring element 50 are pivotally mounted, in this case, to a support portion 56 which extends along the base wall portion 28. It can be seen that the pair of pivot links 48a, 48b are of unequal length and pivotally connected between the upper housing portion 16 and the support portion 56. The support portion 56 includes an anchor flange 56a and the spring element 50 is coupled between the upper housing portion 16 and the anchor flange 56a. The intermediate position is thus also the position in which the spring element reaches its maximum stretch or deflection.

While the transfer portion 22, with its plurality of pivot links 48a, 48b, offers an effective transfer of the device 10 to the open position, as will be described, the transfer portion may be provided, if desired, with other configurations such as by the use of single or multiple pivot axis hinges with or without assistive springs.

The transfer portion 22 includes a linear actuator 60 which acts between the lower and upper housing portions 18, 16 respectively. The linear actuator 60 may, if desired, be removable from the lower and/or upper housing portions to permit manual closure thereof. This may be achieved by provided a removable coupling element 60a, 60b between either end of the linear actuator 60 and the corresponding upper and lower housing portions. This may be useful in cases where the linear actuator is unable to operate to close the device.

The device 10 is also provided with a control portion 64 for controlling the signaling elements. The control portion 64 includes a printed circuit processor portion 66 which communicates with the signaling elements 44, via a plurality of cables shown at 68. A control housing shown at 64a encloses the processor portion 66 and is mounted on the base wall portion 28 to one side of the left hand hinge mechanism 48, as viewed in FIG. 6. The control portion 64 also communicates with a remote actuator 70 located within the vehicle 40 by way of one or more of the cables 68, or by some other form of wired and/or wireless data link, for example by using a suitable frequency or frequency pattern, or carrier frequency, such as by the use of 802.11 or other similar communication protocols.

The upper housing portion 16 includes an outer skin element 72 and an inner skin element 74, where the inner skin element 74 is within a boundary defined by the skirt member 36. The inner and outer skin elements 72, 74 are spaced from one another to form a space 76 to receive the cables 68. In this case, the control housing 64a is positioned on the base wall portion 28 but could be located in any number of other locations on the device 10, including within a space or cavity 78 provided in the side wall portions 26 of the lower housing portion as shown 18 at or in the space 76 in the upper housing portion 16.

The base wall portion 28 may also be a mounting location for a heating element as shown at 82 in FIG. 3 for heating the inner chamber 24. The heating element 82 may be different forms, including a resistive carbon composite material and may be useful in some examples to melt accumulated snow or ice when the device is used in winter freezing conditions. The inner chamber may also be provided with one or more drain holes to drain the melt water as needed.

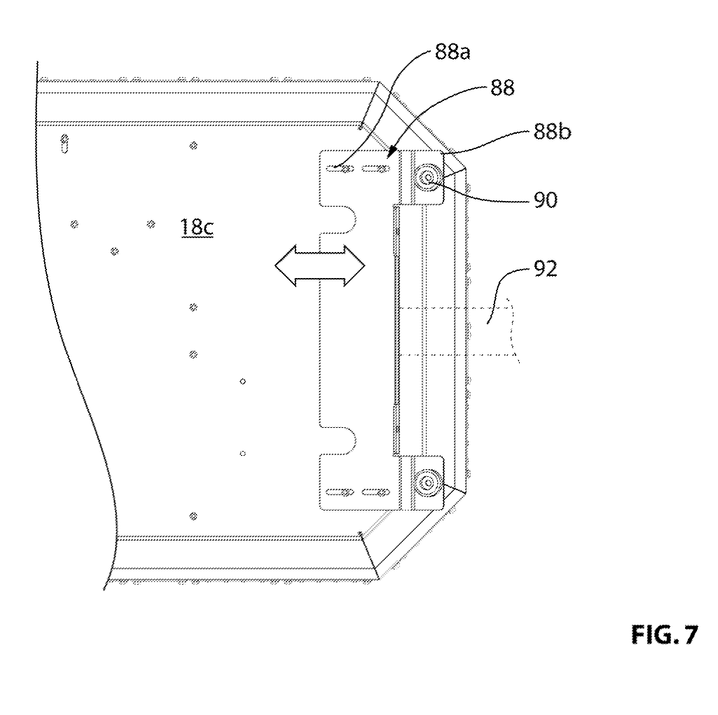

Referring to FIGS. 4 and 7, a support frame arrangement is provided at 86 for mounting the lower housing portion 18 on the vehicle 14. In this case, the support frame arrangement 86 includes a pair of support frame portions 88 which are mounted directly on a bottom surface 18c of the lower housing portion by way of fasteners which are mounted in corresponding slots 88a, allowing for lateral adjustment as desired, depending on the profile of the roof section 14a of the vehicle 14, for instance. In this case, each support frame portion 88 includes a pair of lateral tabs 88b extending laterally outwardly and of sufficient surface area to receive a rubber mounting bumper 90 thereon, the latter providing a contact point against the vehicle 14 to allow for some limited relative movement between the device 10 and the vehicle 14. The support frame arrangement 88 is also provided with a number of external fasteners, clips, cables, belts, cords or the like as shown schematically at 92 to secure the support frame arrangement 88 to the vehicle 14.

Once installed on the vehicle 14, the device 10 may be used as follows. First, the vehicle operator may depress an appropriate button or directional stick on the remote actuator 70 which dispatches an instructional signal to the control portion 64 to activate the linear actuator 60. Doing so, the linear actuator 60 displaces its piston outwardly, thereby increasing its effective length, thereby causing a resultant displacement of the upper housing portion 16, causing the upper housing portion to move from this closed position to the intermediate position against the biasing force of the spring element 50. Continued activation of the linear actuator 60 causes the upper housing portion 16 to continue its upward displacement beyond the intermediate position toward an open upright position. The exact location of the open upright position may not be critical but a fully upright substantially perpendicular position relative to the base wall portion 28 may be preferred. Once the upper housing portion 16 reaches this open position, the vehicle operator may then deploy the signaling elements 44 as desired, to cause an animated moving arrow to the right, to the left, to make announcements, to spell out graphic or text messages, or the like. The vehicle operator may then activate the heating element 82 to melt snow and ice as it collects in side the lower housing, as needed. Once the need for signaling has ended, the vehicle operator may then deploy the remote actuator 70 to close the device 10 by contracting the linear actuator 60, thereby causing the upper housing portion 16 to move from the open position to the intermediate position, against the biasing action of the spring element 50, then from the intermediate position to the closed position with the assistance of the biasing force of the spring element 50, until the upper housing portion 16 is in its closed position with the lower housing portion. If the latch mechanism 54 is then available, the vehicle operator may activate the control portion to activate the solenoid for its plunger to engage the latch.

The device 10 may also be usable in the closed position, by activating the signaling elements 44 on the outer display surface 26a of the lower housing portion 18 to provide red or amber alert lighting on the lower housing portion 18 which can then cooperate with the additional signaling/messaging by the upper housing portion 16.

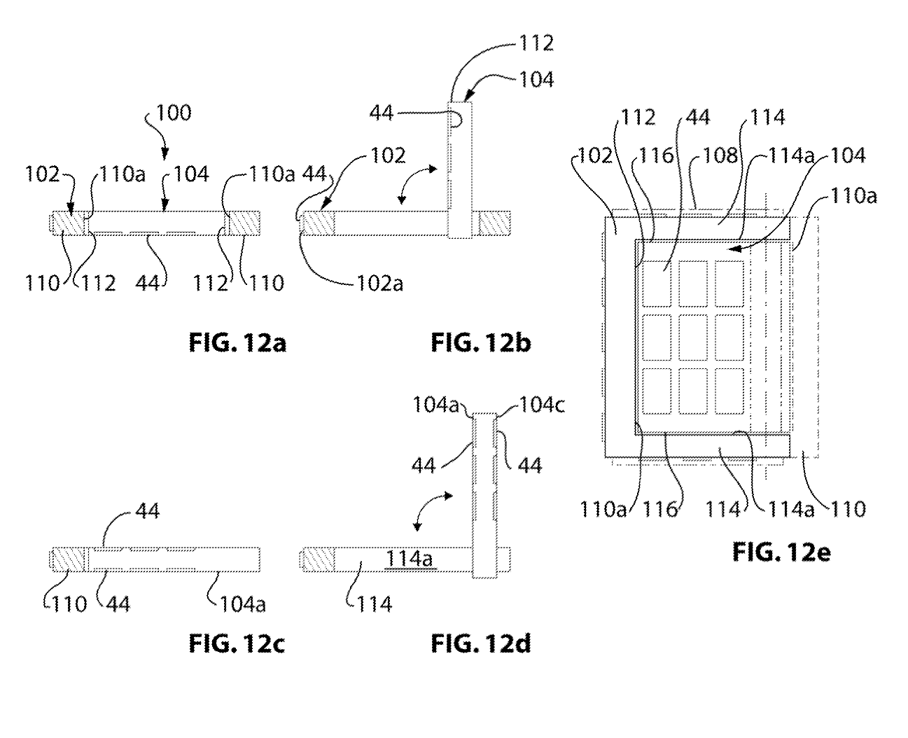

Another device is shown schematically at 100 in FIGS. 12a to 12e. In this case, the lower housing portion can be seen to take the form of a first outer display portion 102, while the upper housing portion serves as a second inner display portion 104 nested or otherwise engaged with the first outer display portion 102. The second inner display portion 104 is thus movable relative to the first outer display portion 102 between an inclined position and an upright position. Further, the second inner display portion 104, when in the inclined or closed position as shown in FIG. 12a, has substantially common vertical dimensions, and/or a substantially common upper periphery and/or a substantially common lower periphery when in the closed position.

The first outer display portion 102 can be seen to provide an outer circumferential first display surface 102a which provides a convenient mounting position for a plurality of signaling elements 44. The second inner display portion 104 has at least one planar second display surface 104a also carrying signaling elements 44 which are visible to oncoming traffic when the second inner display portion is in the inclined position. In FIGS. 12c, 12d, the display surfaces 104a, 104b are both shown with signaling elements 44.

The transfer portion 22, as described above, and in one example, provides a self-contained pivot and support mechanism for the upper housing portion 16 for movement relative to the lower housing portions 18, in one example, without the need for external frame structure. However, an external frame portion may be provided, for example, as shown at 108 in the alternative schematic side view of FIG. 12e, if desired, to pivotally support the second inner display panel 104 relative to the first outer display panel 102.

It can thus be seen that, in this example, the first outer and second inner display portions 102, 104 nest together or otherwise engage or locate adjacent one another in the closed position. The first outer display portion 102 has one transverse portion 110 (as in FIGS. 12c, 12d) or two transverse portions 110 (as in FIGS. 12a, 12b) to be oriented with a transverse axis of the vehicle, along with corresponding one or more first transverse boundaries 110a. Meanwhile, the second inner display portion 104 has one or a pair of second transverse boundaries 112, each being complementary a corresponding first transverse boundary 110a.

Still further, the first outer display portion 102 may be seen to include a pair of opposed first longitudinal portions 114 to be oriented along a longitudinal axis of the vehicle. Each of the opposed first longitudinal portions have, in this case, a first longitudinal boundary 114a, which is complementary with a corresponding one of a pair of opposed second longitudinal boundaries 116 on the second inner display portion.

While the device 10 includes an upper housing portion which is movable relative to a lower housing portion, it will be understood that each housing portion may be configured to include one or more sections of the other housing portion and vice versa. For instance, there may be examples where an upper section of the second outer peripheral edge region 16a may carry a corresponding front section 26c of the side wall portions 26 as shown in dashed lines in FIG. 10, or a side section 26d of the side wall portions 26, as shown in dashed lines in FIG. 4, or various other combinations thereof. While the device is useful for signaling, it may also be useful for other purposes, such as for storage and the like, without the need for the signaling elements.

While the present invention has been described for what are presently considered the preferred embodiments, the invention is not so limited. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A signaling device, comprising a housing, the housing being arranged for mounting on a roof section of an emergency vehicle, the housing having an upper housing portion and a lower housing portion, a transfer portion for transferring the upper housing portion relative to the lower housing portion between a closed position and an open position, the upper and lower housing portions being further provided with complementary peripheral regions which, when engaged in the closed position, form a weather resistant inner chamber, the upper housing portion having an inner surface, a plurality of signaling elements mounted on the inner surface, the inner surface and/or the signaling elements being operable to be visible to oncoming traffic when the upper housing portion is in the open position.

2. A device as defined in claim 1, the lower housing portion further including a plurality of side wall portions and a base wall portion.

3. A device as defined in claim 2, the lower housing portion including a first outer peripheral edge region, the lower housing portion further including a top wall portion with an inner peripheral edge region.

4. A device as defined in claim 3, wherein the upper portion has a second outer peripheral edge region to engage the inner peripheral edge region.

5. A device as defined in claim 4, the upper housing portion being substantially planar.

6. A device as defined in claim 5, the second outer peripheral edge region further comprising a skirt member.

7. A device as defined in claim 4, at least one of the inner and second outer peripheral edge regions including a weather barrier element.

8. A device as defined in claim 7, wherein the side wall portions include at least one outer display surface, the display surface including a plurality of signaling elements.

9. A device as defined in claim 8, wherein the signaling elements include one or more than one speaker, buzzer, light or graphical or numerical readout.

10. A device as defined in claim 9, wherein the one or more than one light includes one or more than one LED, incandescent light element and fluorescent light.

11. A device as defined in claim 2, wherein the transfer portion is operable to transfer the upper housing portion about at least one pivot axis.

12. A device as defined in claim 11, wherein the transfer portion is operable in a first phase to translate the upper housing portion between the closed position and a first intermediate position and a second phase between the first intermediate position and the open position.

13. A device as defined in claim 12, wherein the transfer portion includes a plurality of pivot links

14. A device as defined in claim 13, wherein the transfer portion includes at least one spring element.

15. A device as defined in claim 14, wherein the spring element is operable to bias the transfer portion from the first intermediate position to the closed position and/or from the first intermediate position to the open position.

16. A device as defined in claim 15, wherein the transfer portion includes a support portion extending along the base wall portion, the pivot links include a pair of pivot links of unequal length pivotally connected between the upper housing portion and the support portion.

17. A device as defined in claim 16, wherein the support portion includes an anchor flange, the spring element being coupled between the upper housing portion and the anchor flange.

18. A device as defined in claim 12, the transfer portion including a linear actuator acting between the lower and upper housing portions.

19. A device as defined in claim 18, the linear actuator being removable from the lower and/or upper housing portions to permit manual closure thereof.

20. A device as defined in claim 19, further comprising a control portion for controlling the signaling elements.

21. A device as defined in claim 20, wherein the control portion includes a processor portion operable to communicate with the signaling elements.

22. A device as defined in claim 21, wherein the control portion includes a control housing enclosing the processor portion.

23. A device as defined in claim 22, wherein the control housing is positioned on the base wall panel.

24. A device as defined in claim 23, further comprising a plurality of cables between the processor portion and the signaling elements to form a plurality of communication paths therebetween.

25. A device as defined in claim 24, wherein the upper housing portion includes an outer skin element and an inner skin element, the outer and inner skin elements being spaced to form a space to receive the cables.

26. A device as defined in claim 1, further comprising a heating element for heating the inner chamber.

27. A method of providing emergency signaling on an emergency vehicle, comprising the steps of providing a housing, arranging the housing to be mountable on a roof section of the emergency vehicle, providing the housing having with an upper housing portion and a lower housing portion, transferring the upper housing portion relative to the lower housing portion between a closed position and an open position, providing the upper and lower housing portions with complementary peripheral regions which, when engaged in the closed position, form a weather resistant inner chamber, providing the upper housing portion with an inner surface, locating one or more signaling elements on the inner surface, and arranging the inner surface and/or the signaling elements to be visible to oncoming traffic when the upper housing portion is in the open position.
